(19) United States
(12) Patent Application Publication
(10) Pub. No.: US 2023/0203865 A1
(43) Pub. Date: Jun. 29, 2023

(54) SLIDING DOOR SYSTEM AND GUIDE THEREFOR

(71) Applicant: HOMEVIEW CAVITY SYSTEMS LIMITED, Christchurch (NZ)

(72) Inventor: Howard Anthony STONE, Hamilton (NZ)

(21) Appl. No.: 17/999,184

(22) PCT Filed: May 19, 2021
(86) PCT No.: PCT/NZ2021/050083

§ 371 Date: Nov. 17, 2022

(30) Foreign Application Priority Data
May 19, 2020 (NZ) 764551

(51) Int. Cl. E05D 15/06; E06B 3/46

(52) U.S. Cl. CPC E05D 15/0652; E05D 15/063; E06B 3/4654; E05D 15/0656; E05Y 2800/27; E05Y 2800/104; E05Y 2900/114; E05Y 2900/112; E05Y 2900/614

(57) ABSTRACT

A sliding door system including a wall cavity between a first wall lining and a second wall lining, a door frame adjacent the wall cavity, a guide extending across the top of the door frame and the top of the cavity, and a door panel suspended from carrying means supported by the guide, the guide including a plate, and two wings extending from the plate to define a cavity between the wings and the plate, characterised in that the cavity is closer to a second end of the plate than it is to a first end of the plate and that the distance from the door panel to the first wall lining is greater than the distance from the door panel to the second wall lining.

### TECHNICAL FIELD

The present invention provides a sliding door system and a guide for use in the system.

### BACKGROUND

Any discussion of the prior art is not an admission that such art forms part of the common general knowledge in the field.

The present invention has been developed in relation to cavity slider doors. A traditional cavity slider door system includes a pocket formed by structural elements of a wall adjacent a doorway, each of two outer planar vertical sides of which is covered by wall lining material. A bottom guide is provided along a bottom side of the pocket. A top guide continuously extends along the top side of the pocket, and out across the lintel of the doorway. A door panel is provided on a bottom edge with a groove adapted to engage the bottom guide, and on a top edge with engagement means to engage with a roller carriage located in the top guide. In a closed position, the door panel extends across the desired extent of the doorway, with one edge staying within the pocket and engaged with the bottom guide. The door can be moved into an open position by a user sliding the door panel into the pocket, so that the engagement means move along the top guide to support the door, and the bottom guide positions the door panel in vertical orientation within the pocket.

The top guide may include a base plate for engagement with the top structural component of the pocket and lintel, and two side walls substantially perpendicular to the base plate, each terminating with a bottom plate to partially close a U-shaped cavity. The U-shaped cavity is adapted to hold a roller carriage, to engage with the door panel and allow it to travel along the top guide.

Cavity sliding doors can be incorporated into walls having stud cavities of various standard sizes, such as 90 millimetres (mm), 100 mm, 140 mm, or 190 mm.

The door panel is positioned at the centre of the pocket, which advantageously allows the wall linings on either side of the pocket to support attachments such as picture hooks.

However, when the cavity between the wall linings is being used as the pocket for a cavity slider door, it cannot be used for other types of services that are often run through the stud cavity of a wall of a building, such as electrical wiring, or water pipes. This introduces limitations to the use of the wall in which a cavity slider door is positioned, because any type of fitting that requires a supply of power or water cannot be placed on that wall, because of the inability to provide the necessary supply through the wall cavity. This is a particular limitation in the design of compact spaces, such as hotel rooms, or apartments.

It is an object of the present invention to overcome at least one of the disadvantages of the prior art, or at least provide the public with a useful choice.

### DISCLOSURE OF INVENTION

Therefore the present invention provides a guide for a sliding door, the guide including a plate, and two wings extending from the plate to define a cavity between the wings and the plate, characterised in that the cavity is closer to a second end of the plate than it is to a first end of the plate.

Preferably the plate extends longitudinally, and the first end is one longitudinal side of the plate, and the second end is the other longitudinal side of the plate.

In a preferred embodiment, the plate is adapted to be secured to structural elements of the interior of a wall and/or a door frame. Preferably the plate is adapted to be secured near the first end and the second end. More preferably each of the first end and the second end include holes for receiving securing means.

Preferably one or both of the wings includes one or more engagement protrusions on the side of the wing that is not the side adjacent the cavity.

In a preferred embodiment the cavity is adapted to receive carrying means for a door panel. Preferably the carrying means is a roller carriage. Preferably each of the wings includes a lower plate that partially closes the open end of the cavity opposite the plate. More preferably the lower plates are adapted to support the movement of a roller carriage suspending a door panel by door engagement means that can pass through the open end of the cavity. Generally, the carrying means will include a plurality (such as two) of roller carriages, so as to allow movement of the top surface of the suspended door in a substantially horizontal, reciprocating direction. Each of such a plurality of roller carriages may be the same or different in form.

In preferred embodiments the cavity is adapted to receive a roller carriage from which is suspended a cassette configured to be fixed to a suspended door, wherein the cassette provides for fixing to the suspended door and roller carriage. Such a cassette is adapted to allow the user to engage and disengage the roller carriage from the suspended door so as to facilitate installation and removal of the suspended door. The cassette is preferably incorporated within a recess (such as a channel) running longitudinally along the top face of the suspended door. For installation, servicing and removal of the suspended door, part of the cassette can be to removed from the end profile of the door so as to disengage the roller carriage from the cassette.

Such a cassette may include a number of parts, including: (a) a housing for fixing (such as screwing) to the suspended door; and (b) a running gear holder that engaged with the roller carriage retained in the cavity of the top guide (typically through the use of a suspension bolt that couples the roller carriage to the running gear holder. The running gear holder and the housing may be coupled to each other through a retaining mechanism wherein the retaining mechanism may be released by the action of an actuator mounted to the outward, end surface of the running gear holder. An example of such a roller carriage and cassette are as widely supplied by EKU and/or Hafele as EKU Porta system. An advantage of using the EKU Porta system in combination with the top guide of the present invention is the ability to provide an aesthetically pleasing door surround profile. In particular, by recessing the cassette within the top surface of the suspended door, the roller mechanism is largely concealed from view in use, without the need to use further hardware around the door surround. Through use of the actuator, the housing (and hence suspended door) and the running gear holder can be disengaged to allow for removal of the door, and vice versa.

On the other hand, conventional cavity sliders use one or more removable head jambs running parallel to the top guide. The removable head jamb in such systems acts to conceal a roller carriage mechanism that is fixed to the top surface of the suspended door, rather than recessed in it. By fixing the roller carriage mechanism to the top surface of the door there is a need to conceal the mechanism by the use of an additional removable head jamb running parallel to the top guide. Nonetheless, in order to install, and maintain the roller carriage, the removable head jamb must be able to be easily removed, and accordingly such removable head jambs are typically provided with user-accessible screws that, despite efforts to conceal them with plugs or covers, nonetheless are visible to all in the vicinity of the door. Further such removable head jambs typically need to be painted to the colour of the remainder of the door surround, yet removal and reinstallation of the removable head jamb may lead to deterioration of the paint thus requiring further maintenance. Such removable head jambs are regarded as less aesthetically pleasing than a door surround that avoids the use of such removable head jambs (and screw holes) and instead uses a cassette recessed into the top of the suspended door.

However the advantages with using the recessed cassette and roller carriage extend beyond aesthetics. The present invention provides a system whereby services, such as pipes or wires, may be installed within the wall space adjacent to the cavity slider. It is not uncommon for such services to require inspection and/or maintenance. As such the ability to easily remove the suspended door to access those services is advantageous. Such an ability is particular important in commercial settings where a technician may need to inspect and/or maintain a multitude of services, so that minimizing delay can present a significant cost saving to the building owner. By providing a system whereby services, such as pipes or wires, may be installed within the wall space adjacent to the cavity slider and the suspended door may be readily removed without separately removing a removable head jamb, the combination of elements provided by the invention provides significant synergies.

Preferably the guide is integrally formed. In a preferred embodiment, the guide is formed by extrusion. Alternatively, it could be formed by bending or moulding. Preferably the guide is made of aluminium, an aluminium alloy, nylon or other plastics.

In a preferred embodiment, the distance from the centreline of the cavity to the first end may be about 1.5 to 4 times (such as 1.5-2.5 times; such as about 2.1 times) as far as the distance from the centreline of the cavity to the second end.

The present invention further provides a sliding door system including a wall cavity between a first wall lining and a second wall lining, a door frame adjacent the wall cavity, a guide extending across the top of the door frame and the top of the cavity, and a door panel suspended from carrying means supported by the guide, characterised in that the distance from the door panel to the first wall lining is greater than the distance from the door panel to the second wall lining.

In a preferred embodiment, the sliding door system also includes a bottom guide for the door panel.

Preferably the space between the door panel and the first wall lining is adapted to receive services. More preferably the services are wires or pipes.

In a first preferred embodiment, the first wall lining is adapted to provide a shower wall.

Preferably the shower wall is provided with one or more plumbing fittings selected from one or more: shower mixer, shower hose, shower head support rail, fixed shower rose, and tap. More preferably the space between the door panel and the first wall lining includes pipes to convey water to or from the or each plumbing fitting.

In a second preferred embodiment, the first wall lining is adapted to carry a sink or vanity unit. Preferably the sink and/or first wall lining is provided with one or more plumbing fittings selected from one or more: faucet, mixer, tap, waste water trap. More preferably the space between the door panel and the first wall lining includes pipes to convey water to the or each plumbing fitting.

In a third preferred embodiment, the first wall lining is adapted to hold a mounted device. Preferably the device is a display screen or television. More preferably the space between the door panel and the first wall lining includes wires to carry electricity and/or communications signals to the device.

In a fourth preferred embodiment, the first wall lining is adapted to hold a heating and/or cooling appliance. Preferably the device is the internal unit of a heat pump. More preferably the space between the door panel and the first wall lining includes wires to carry electricity to the appliance. More preferably the space between the door panel and the first wall lining includes pipes to carry air and/or water to the appliance.

In a fifth preferred embodiment, the first wall lining is adapted to have a toilet installed on its outside surface. Such a toilet may have a cistern, such that the cistern is external or may even advantageously be a concealed cistern such that it is installed in a sufficient deep wall cavity. It will be appreciated that the present invention allows for the installation of a concealed cistern in a significantly less deep cavity than conventional systems wherein the cavity of the top guide is centrally positioned. Preferably the toilet and/or first wall lining is provided with one or more plumbing fittings selected from one or more: water supply, cistern, toilet bowl. More preferably the space between the door panel and the first wall lining includes pipes to convey water to the or each plumbing fittings (such as cistern or sink).

### BRIEF DESCRIPTION OF THE DRAWINGS

By way of non-limiting example only, a preferred embodiment of the invention is described in detail below with reference to the accompanying drawings, in which:

FIG. 1 shows the cross-section of a top guide according to the present invention;

FIG. 2 is a plan view of a potential installation of a cavity slider door according to the present invention;

FIG. 3 is a cross-section of the installation of FIG. 2 along the line A-A;

FIG. 4 is a cross-section of the installation of FIG. 2 along the line B-B;

FIG. 5 is a perspective view from a first side of part of a single indicative mock-up of two potential examples of uses for the present invention; and

FIG. 6 is a perspective view from a second side of the single indicative mock-up of FIG. 5.

### BEST METHOD OF PERFORMING THE INVENTION

By way of example, the present invention is now described in detail by reference to preferred embodiments.

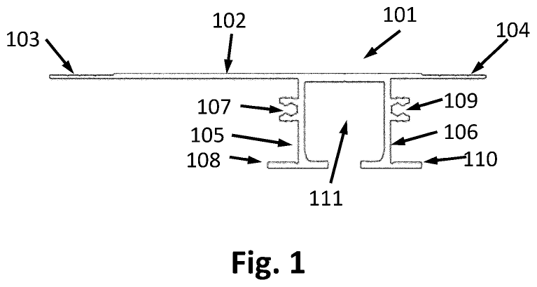

FIG. 1 shows the cross section of a top guide 101 for use in the present system. Top guide 101 can be extruded in lengths of this cross-section from suitable materials such as an aluminium alloy. Top guide 101 includes a top plate 102. Each of a first end 103 and a second end 104 of top plate 102 may be adapted to be secured to structural elements of a building, such as framing defining a wall cavity, or a door frame. As shown, this may be achieved by each of first end 103 and second end 104 being thinner than the main body of top plate 102. One or more of first end 103 and second end 104 may also include one or more holes to allow the passage of securing means such as screws or similar through the first end 103 and/or second end 104 of top plate 102.

Integrally formed with top plate 102 of top guide 101 are a first wing 105 and a second wing 106. First wing 105 extends substantially perpendicularly from top plate 102. Typically each of the first and second wings shall extend from the top plate for substantially the same distance, such as 24-33 mm, for example 26-31 mm (such as about 27 mm). On the side closer to first end 104, first wing 105 may include one or more first engagement protrusions 107. The or each first engagement protrusion may be configured to optionally receive a fixing member (such as a screw) in or out of the plane of the cross section shown in FIG. 1. Such a fixing member (such as a screw) may be used to mount the top guide to a vertical support member, such as door jamb 203 where present. At an end of first wing 105 distal to top plate 102, a first bottom plate 108 extends from either side of first wing 106, substantially parallel to top plate 102.

Second wing 106 extends substantially perpendicularly from top plate 102 at a position closer to second end 104 than is first wing 105. On the side closer to second end 104, second wing 106 may include one or more second engagement protrusions 109. The or each second engagement protrusion may be configured to optionally receive a fixing member (such as a screw) in or out of the plane of the cross section shown in FIG. 1. Such a fixing member (such as a screw) may be used to mount the top guide to a vertical support member, such as door jamb 203 where present. At an end of second wing 106 distal to top plate 102, a second bottom plate 110 extends from either side of second wing 106, substantially parallel to top plate 102. First wing 105 and second wing 106 are separated so that there is a gap between first bottom plate 108 and second bottom plate 110. Together, top plate 102, first wing 105, and second wing 106 define a U-shaped cavity 111 dimensioned to receive a roller carriage, with the wheels of the roller carriage supported upon, and running along, first bottom plate 108 and second bottom plate 110.

Unlike a standard top guide for a cavity slider door, in top guide 101 both first wing 105 and second wing 106 are closer to second end 104 than to first end 102, so that top guide 101 is not symmetrical, but top plate 102 extends for a significant offset length between first wing 105 and first end 103. For example, the U-shaped cavity 111 between first wing 105 and second wing 106 may be about 20-30 mm (such as 26 mm). For example, the second end 104 may be about 10-30 mm from second wing 106. By way of another example, the second end 104 may be about 20-40 mm (such as about 31 mm) from second wing 106. For example, the first end 103 may be about 60-80 mm from first wing 105. By way of another example, the first end 103 may be about 70-90 mm (such as about 81 mm) from second wing.

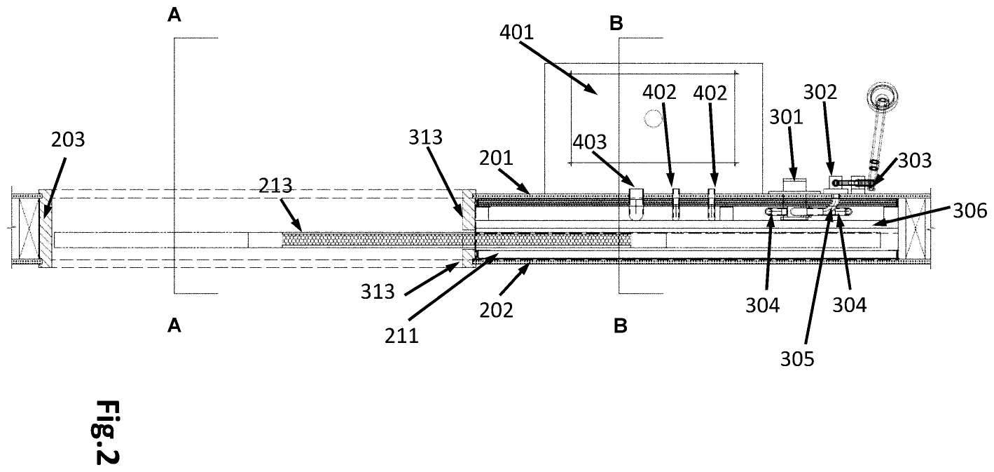

FIG. 2 shows a plan view of a potential installation of a cavity slider door system according to the present invention. A wall cavity is defined between a first wall lining 201 and a second wall lining 202, adjacent a door frame and aligned therewith so that a single continuous top guide extends across the top of the door frame and along the top of the cavity. The structural elements supporting first wall lining 201, the structural elements supporting second wall lining 202, and the top guide together form a wall cavity body. Although the door frame is shown in this example as having an end jamb 203, it will be appreciated by one skilled in the to art that it will sometimes be architecturally desirable not to include this feature, for example when the cavity slider door is one of a pair that will meet together to fill a larger door frame. In such installations, a stop for the roller carriage may be included in the U-shaped cavity of the top guide at a desired location.

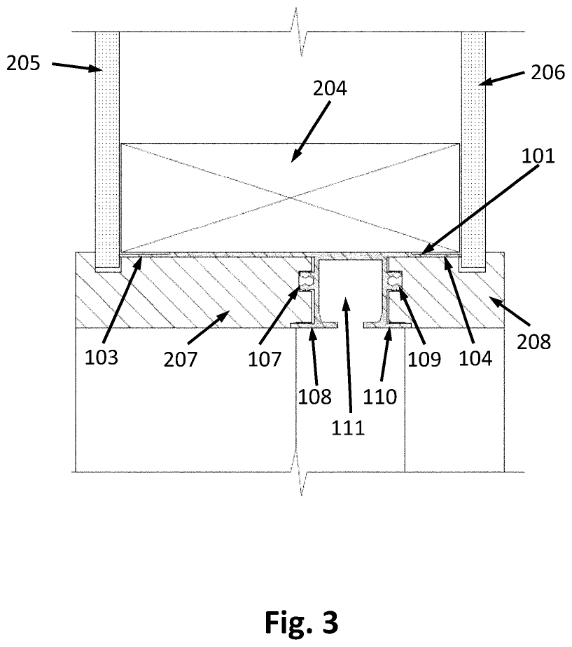

FIG. 3 shows the installation of the cavity slider system in the doorway. A doorway structural framing member 204 above the doorway is hidden on the sides by a first lining 205, which is continuous with first wall lining 201, and second lining 206, which is continuous with second wall lining 202. Top guide 101 extends along the doorframe with U-shaped cavity 111 accessible from the doorway. In this embodiment, top guide 101 is secured to doorway structural framing member 204 by passing screws through holes provided in each of first end 103 and second end 104 and into doorway structural framing member 204. Other known securing means could be used.

A first head jamb 207 is preferably made of timber. First head jamb 207 includes one or more grooves which receive first engagement protrusions 107, and is supported by first bottom plate 108 and engages with and conceals an edge of first lining 205.

A second head jamb 208 is preferably made of timber. Second head jamb 208 includes one or more grooves which receive second engagement protrusions 109, and is supported by second bottom plate 110 and engages with and conceals an edge of second lining 206.

In light of the unique proportions of the first head jamb 207 and second head jamb 208 which are configured to conceal most of the top plate 102, it may be convenient to be supplied with the top guide 101 and the first head jamb 207 and/or second head jamb 208 as a kit of parts. In one aspect the invention provides a kit of parts including:

(a) a guide for a sliding door, the guide including a plate, and two wings extending from the plate to define a cavity between the wings and the plate, characterised in that the cavity is closer to a second end of the plate than it is to a first end of the plate; and

(b) a first head jamb configured to conceal the plate between the first end and the wing closest to the first end and/or a second head jamb configured to conceal the plate between the second end and the wing closest to the second end.

Preferably the kit of parts is also provided with a roller carriage and cassette for fixing to a suspended door, wherein the cassette to adapted to be fixed to a recess in the top surface of the suspended door.

Generally the first head jamb 207 and the second head jamb will be supplied in the kit of parts. The kit of parts may be supplied as part of a complete door set.

Generally the first head jamb 207 and/or second head jamb 208 will extend from the top plate 101 a distance substantially equal to the distance that the respective first wing 105 and/or second wing 106 extend from the top plate 102.

Where the first protrusion 107 and/or second protrusion 109 are present it may be preferable to provide the respective first head jamb 207 and/or second head jamb 208 configured so as to substantially shroud the first protrusion 107 and/or second protrusion 109. Such a shrouding configuration may be provided in the form of a channel extending longitudinally along the first head jamb 207 and/or second head jamb 208 so as to provide a mated fit with the first protrusion 107 and/or second protrusion 109.

In some examples, the first head jamb 207 and/or second head jamb 208 may be provided with a longitudinal channel configured to engage with and conceal an edge of first lining 205 and/or second lining 208. In some embodiments this channel may extend a short distance (such as 5-20 mm) into the region between the top plate 102 and the head jamb. Advantageously this short extension allows a fixture (such as a hook, J-formed metal piece, or C-channel metal piece) extending from above (such as a ceiling) to hook around the undersurface of the top guide 101 to support its weight and enable the top guide 101 to be directly fixed to the ceiling.

It will be appreciated by one skilled in the art that different aesthetic appearances could be achieved. For example, instead of first head jamb 207 and second head jamb 208, the top guide 101 could engage directly with a ceiling lining, such as plasterboard. In some such instances the weight of the top guide (and door hanging therefrom) can be supported by a fixture (such as a hook, J-formed metal piece, or C-channel metal piece) extending from above (such as a ceiling and/or rafter beam). For example the fixture may hook around the undersurface of the top guide 101 to support its weight and enable the top guide 101 to be directly fixed to the ceiling. Such an embodiment may be particularly well suited to applications where having a door flush to ceiling finish is desired, since such a configuration will typically allow for more efficient ventilation, such as heating. Optional packing can also be included where necessary to position the top guide 101 for the desired aesthetic effect.

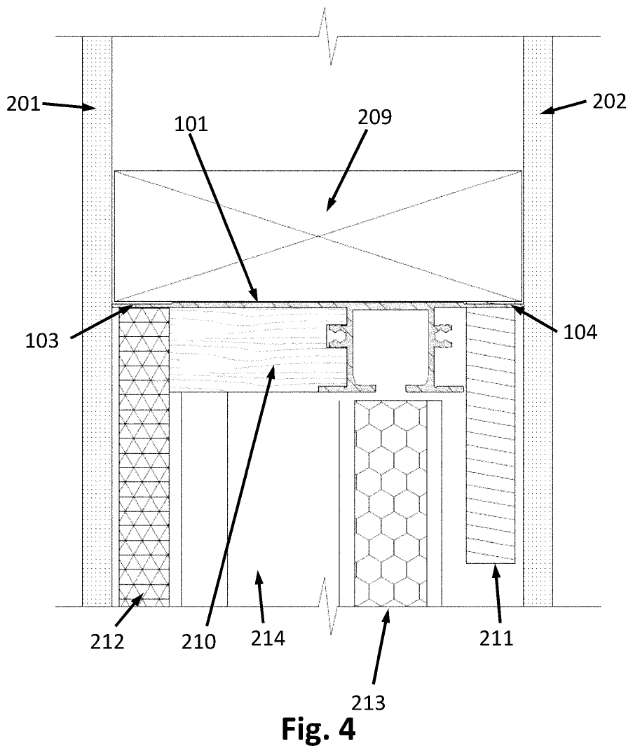

FIG. 4 shows the installation of the cavity slider system in the wall cavity. Cavity top structural member 209 may preferably be continuous with doorway structural framing member 204. Cavity top structural member 209 extends along the top of the cavity between first wall lining 201 and second wall lining 202. Top guide 101 extends along cavity top structural member 209 with U-shaped cavity 111 accessible from the cavity. In this embodiment, top guide 101 is secured to cavity top structural member 209 by passing screws through holes provided in each of first end 103 and second end 104, and into cavity top structural member 209. Other known securing means could be used.

A first side packing 210 includes one or more grooves which receive first engagement protrusions 107 and extend from top plate 102 to first bottom plate 108. First end 103 of top guide 101 is connected to a structural cavity body component 212 adjacent first side packing 210. Structural cavity body component 212 may be made of a material such as an H3.1 structural timber of plywood or strand board. First wall lining 201 is connected to the structural cavity body component 212 by known means.

Second end 104 of the top guide 101 is connected to a timber frame rail 211. Second wall lining 202 is connected to the timber frame rail 211 by known means.

FIG. 4 shows the position of door panel 213 when it is in the cavity. For clarity, the roller carriage is not shown in U-shaped cavity 111, nor are the connectors between the door panel 213 and the roller carriage. These are known features. As shown, there is a space 214 between door panel 213 and structural cavity body component 212. This space is an important feature of the present invention, because it provides a space within the wall cavity for services such as electrical wiring, or plumbing fittings, such as the examples described below in more detail.

First Example—Shower Installation

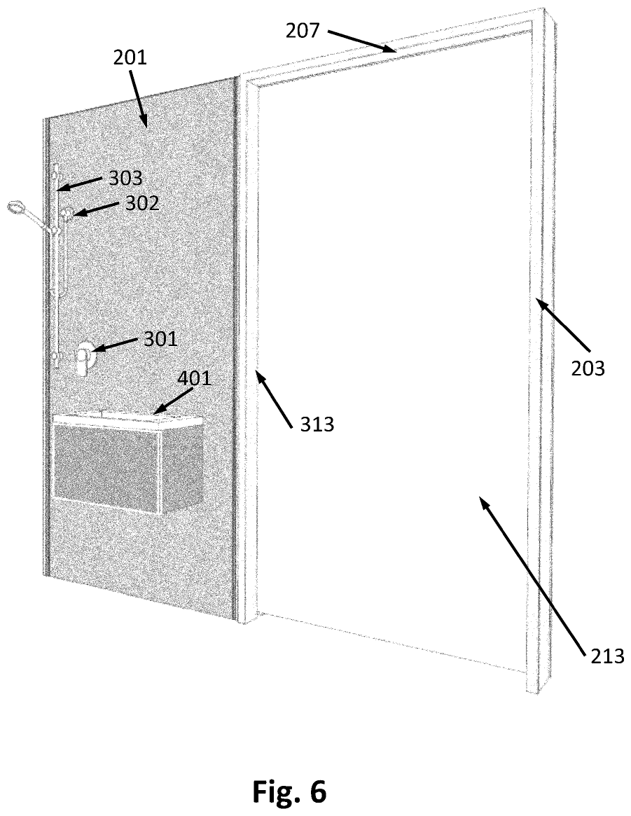

A first example of the use of the cavity slider system according to the present invention is for a door adjacent a shower area, and is described with particular reference to FIGS. 1, 2, 5 and 6.

The chosen aesthetic appearance for the doorway of the installation shown uses a first head jamb 207 engaged with first protrusion 107 on first wing 105 of top guide 101, a second head jamb 208 engaged with second protrusion 109 on second wing 106 of top guide 101, and a substantially vertical split jamb 313 along the edge of the doorway adjacent the wall cavity.

In this example, first wall lining 201 is adapted to form a lining for shower wall. This may be achieved by any of a variety known means, such as first wall lining 201 being a waterproof panel, or being coated with a waterproof coating or membrane and covered with tiles, or being a side wall of a prefabricated shower cavity made of acrylic or another material.

In order to provide a shower area adjacent the sliding door, first wall lining 201 is to be fitted with fittings, which in this example include a shower mixer 301, a shower hose 302, and a shower head support rail 303. (It will be appreciated that alternative fittings could be used, such as a fixed shower rose instead of the shower hose and shower head support rail, taps instead of a mixer, and that multiple water outlets and/or mixers or taps could be provided.)

For the shower to function, pipes carrying hot and cold water need to extend from the ceiling cavity to the shower mixer 301, and at least one pipe needs to extend from the shower mixer 301 to the shower hose 302. For the prior art models of cavity slider door, this would be impossible, because there is insufficient space within the wall cavity to allow pipes to run. However, the system of the present invention provides a space 214. A series of plumbing support rails 306, made of timber or a similar material, can be installed within the space 214.

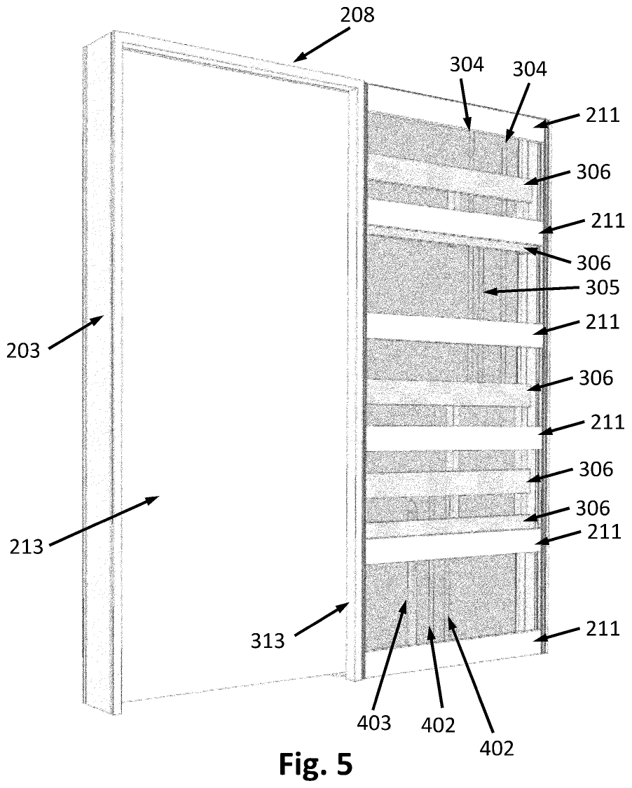

As shown in FIGS. 2 and 5, in this example, shower inlet pipes 304 can run through the space 214 to the inlet ports on shower mixer 301, and a shower mixer outlet pipe 305 can also run through the space 214 from shower mixer 301 to the inlet port on shower hose 302, supported if necessary by connection to one or more plumbing support rails 306.

Shower head support rail 303 can be connected by conventional securing means such as screws through first wall lining 201 to engage with one or more (two in this example) plumbing support rails 306.

In this way, the cavity slider system of the present invention permits the installation of fittings for a shower area on the same wall cavity which houses the door panel in the open position. This provides a useful new option for designers and architects, which was not possible using the prior art systems.

Second Example—Vanity Installation

A second example of the use of the cavity slider system according to the present invention is for a door adjacent a wall on which a sink or vanity unit is to be installed, and is described with particular reference to FIGS. 1, 2, 5 and 6.

The chosen aesthetic appearance for the doorway of the installation shown uses a first head jamb 207 engaged with first protrusion 107 on first wing 105 of top guide 101, a second head jamb 208 engaged with second protrusion 109 on second wing 106 of top guide 101, and a substantially vertical split jamb 313 along the edge of the doorway adjacent the wall cavity.

In this example, first wall lining 201 may be a known type of wall lining, such as plasterboard, and may be partially additionally covered with a tile splashback or mirror, or include appropriate waterproof coatings or membranes to comply with building code requirements.

In this second example, first wall lining 201 is to be fitted with fittings, which include a sink 401. The sink 401 may be fitted with a faucet, mixer, and/or taps, and a waste water trap, which are not shown for clarity. Alternatively, a mixer for water to the sink may be mounted elsewhere on first wall lining 201.

For the sink to function, pipes carrying hot and cold water need to extend from the floor or ceiling to the sink, and a waste water pipe needs to extend from the sink to the floor. For the prior art models of cavity slider door, this would be impossible, because there is insufficient space within the wall cavity to allow pipes to run. However, the system of the present invention provides a space 214. A series of plumbing support rails 306, made of timber or a similar material, can be installed within the space 214.

As shown in FIGS. 2 and 5, in this example, sink inlet pipes 402 can run through the space 214 to inlet ports on the sink 401, and waste water pipe 403 can run through the space 214 from the outlet for the sink 401 to the floor, supported if necessary by connection to one or more plumbing support rails 306.

Sink 401 can be connected by conventional securing means such as screws through first wall lining 201 to engage with one or more (two in this example) plumbing support rails 306.

In this way, the cavity slider system of the present invention permits the installation of fittings for a sink or vanity unit on the same wall cavity which houses the door panel in the open position. This provides a useful new option for designers and architects, which was not to possible using the prior art systems.

Third Example—Device Installation

A third example of the use of the cavity slider system according to the present invention is for a door adjacent a wall on which a mounted device is to be installed. This example is not shown in the drawings.

In this example, the first wall lining may be a known type of wall lining, fitted with mounting means such as a bracket to support a display screen or television.

For the device to function, wires carrying electrical power, and communications signals (such as co-axial, Ethernet or fibre-optic cables) need to extend from the ceiling space (or from the floor space) to the device. It is aesthetically desirable to have these travel through the wall cavity to face plates that are mounted as close as possible to the device, preferably behind where the device will be mounted. For the prior art models of cavity slider door, this would be impossible, because there is insufficient space within the wall cavity. However, the system of the present invention provides a space through which wires can be run. There is also room for the space to include one or more support rails to which the wires can be connected, to keep them neat and easy to locate.

In this way, the cavity slider system of the present invention permits the installation of a device on the same wall cavity which houses the door panel in the open position. This provides a useful new option for designers and architects, which was not possible using the prior art systems.

Fourth Example—Heating and/or Cooling Appliance Installation

A fourth example of the use of the cavity slider system according to the present invention is for a door adjacent a wall on which a heating or cooling appliance is to be installed. This example is not shown in the drawings.

In this example, the first wall lining may be a known type of wall lining, fitted with mounting means such as a bracket to support a heating and/or cooling appliance. This may be an indoor unit for a heat pump.

For the appliance to function, wires carrying electrical power need to extend from the ceiling space (or from the floor space) to the appliance. In the case where the heating appliance is part of a heat pump system or central heating system, pipes for carrying air or water to or from the appliance may also be needed, and it may be necessary to install features such as condensers or pumps near the appliance. For the prior art models of cavity slider door, this would be impossible, because there is insufficient space within the wall cavity. However, the system of the present invention provides a space through which wires and/or pipes can be run. There is also room for the space to include one or more support rails to which the wires and pipes can be connected, and which can support the installation of accessory units within the wall cavity.

In this way, the cavity slider system of the present invention permits the installation of a heating and/or cooling appliance on the same wall cavity which houses the door panel in the open position. This provides a useful new option for designers and architects, which was not possible using the prior art systems.

The embodiments shown and described in detail herein are by way of example only. The present invention is intended to include such modifications and variations thereto as may be obvious to one skilled in the art.

### Reference Numerals

101 top guide

102 top plate

103 first end

104 second end

105 first wing

106 second wing

107 first protrusion

108 first bottom plate

109 second protrusion

110 second bottom plate

111 U-shaped cavity

201 first wall lining

202 second wall lining

203 end jamb

204 doorway structural framing member

205 first lining

206 second lining

207 first head jamb

208 second head jamb

209 cavity top structural member

210 first side packing

211 timber frame rail

212 structural cavity body component

213 door panel

214 space

301 shower mixer

302 shower hose

303 shower head support rail

304 shower inlet pipes

305 shower mixer outlet pipe

306 plumbing support rails

313 split jamb

401 sink

402 sink inlet pipes

403 waste water pipe

1. A guide for a sliding door, the guide including a plate, and two wings extending from the plate to define a cavity between the wings and the plate, characterised in that the cavity is closer to a second end of the plate than it is to a first end of the plate.

2. The guide according to claim 1 wherein the distance from the centreline of the cavity to the first end is about 1.5 to 4 times as far as the distance from the centreline of the cavity to the second end.

3. The guide according to claim 1 wherein the distance from the centreline of the cavity to the first end is about 1.5-2.5 times as far as the distance from the centreline of the cavity to the second end.

4. The guide according to claim 1 wherein the cavity is adapted to receive carrying means for a door panel.

5. The guide according to claim 4 wherein the carrying means is a roller carriage.

6. The guide according to claim 1 wherein each of the wings includes a lower plate that partially closes the open end of the cavity opposite the plate.

7. The guide according to claim 1 wherein the lower plates are adapted to support the movement of a roller carriage suspending a door panel by door engagement means that can pass through the open end of the cavity.

8. The guide according to claim 1 wherein the plate extends longitudinally, and the first end is one longitudinal side of the plate, and the second end is the other longitudinal side of the plate.

9. The guide according to claim 1 wherein one or both of the wings includes one or more engagement protrusions on the side of the wing that is not the side adjacent the cavity.

10. A kit of parts including:
(a) a guide for a sliding door, the guide including a plate, and two wings extending from the plate to define a cavity between the wings and the plate, characterised in that the cavity is closer to a second end of the plate than it is to a first end of the plate; and
(b) a first head jamb configured to conceal the plate between the first end and the wing closest to the first end and/or a second head jamb configured to conceal the plate between the second end and the wing closest to the second end.

11. The kit of parts according to claim 10 including the first head jamb and the second head jamb.

12. The kit of parts according to claim 10 further including a roller carriage and cassette for fixing to a suspended door, wherein the cassette to adapted to be fixed to a recess in the top surface of the suspended door.

13. A sliding door system including a wall cavity between a first wall lining and a second wall lining, a door frame adjacent the wall cavity, a guide extending across the top of the door frame and the top of the cavity, and a door panel suspended from carrying means supported by the guide, characterised in that the distance from the door panel to the first wall lining is greater than the distance from the door panel to the second wall lining.

14. The sliding door system according to claim 13 further including a bottom guide for the door panel.

15. The sliding door system according to claim 13 wherein the space between the door panel and the first wall lining is adapted to receive services.

16. The sliding door system according to claim 15 wherein the services are wires or pipes.

17. The sliding door system according to claim 13 wherein the first wall lining is adapted to provide a shower wall.

18. The sliding door system according to claim 13 wherein the first wall lining is adapted to carry a sink or vanity unit.

19. The sliding door system according to claim 13 wherein the first wall lining is adapted to hold a mounted device.

20. The sliding door system according to claim 13 wherein the first wall lining is adapted to hold a heating and/or cooling appliance.

21. The sliding door system according to claim 13 wherein the first wall lining is adapted to have a toilet installed on its outside surface.
